(19) United States
(12) Patent Application Publication
(10) Pub. No.: US 2011/0012383 A1
(43) Pub. Date: Jan. 20, 2011

(54) Collapsible truck bed animal containment system

(76) Inventor: William John Olander, Goose Creek, SC (US)

Correspondence Address: William Olander, 123 Southwold Circle, Goose Creek, SC, 29445, US

(21) Appl. No.: 12/455,264

(22) Filed: Jul. 20, 2009

(51) Int. Cl. B62D 33/04

(52) U.S. Cl. 296/24.31

(57) ABSTRACT

This invention is consists of consists of a solid top, a front side with two doors, side supports to provide load bearing capacity to the top, a hinged center divider and a solid or frame back side. The sides of the truck bed itself serve as the left (L) and right (R) side walls of the containment system.

The design of the containment system is such that the front and back sides can be folded onto the center divider and secured in the collapsed position for ease of storage when not installed and to provide access to the truck bed itself when the containment system is installed though not in use.

### BACKGROUND OF THE INVENTION

1. Field of the Invention

This invention relates generally to the field of apparatus for containing, housing and safely transporting animals in a truck bed.

2. Description of Related Art

Many devices currently exist for containment, housing and safe transportation of animals in a truck bed. These devices, however, are limited in their functionality. Generally, dog boxes consist of either sturdy, bolt-on boxes that must be mounted semi-permanently or those that require a great deal of effort to install and de-install. Existing containment systems require a great deal of storage space when de-installed and inhibit the available truck bed space when installed but not in use.

Table 1 lists patents that are similar with limited functionality

TABLE 1
Similar Patents with Limited Functionality

| Pat. No. | Issued To | Date of Issue |
|---|---|---|
| 7,100,961 B2 | Russel J. Moen | Sep. 05, 2006 |
| 6,978,736 B2 | Dennis W. Sanford | Dec. 27, 2005 |
| 5,718,190 | Mark A. Tinker | Feb. 17, 1998 |
| 5,524,573 | James E. Hart | Jun. 11, 1996 |
| 6,216,638 B1 | Scott Pivonka | Apr. 17, 2001 |

One of these devices can be found in U.S. Pat. No. 7,100,961 B2 issued to Russel J. Moen on Sep. 5, 2006. However, this device is limited in its functionality because it only provides a shelter over a portion of a truck bed with no means of securing an animal. In U.S. Pat. No. 6,978,736 B2 issued to Dennis W. Sanford on Dec. 27, 2005, the kennel patented by Sanford only provides the floor, front, and divider panel limiting the capability to transport animals to truck owners that already have a cap installed on the truck increasing the overall cost and limiting the load hauling capabilities of the truck. U.S. Pat. No. 5,718,190 issued to Mark A. Tinker on Feb. 17, 1998 provides a method for securely transporting animals, but provides no overhead shelter and merely uses straps to secure animals which could be harmful to the animal should they become entangled during transportation. U.S. Pat. Nos. 5,524,573 issued to James E. Hart on Jun. 11, 1996 and 6,216,638 B1 issued to Scott Pivonka on Apr. 17, 2001 provide a secure kennel for housing animals, but do not provide any method of securing the kennels to a vehicle during transportation.

### SUMMARY OF THE INVENTION

In view of the limitations now present in the prior art, the present invention provides a new and useful method of securely transporting animals in a bolt-on containment unit that is easily de-installed and is collapsible to reduce space requirements when stored or when installed though not in use.

The present invention consists of a solid top, a front side with two doors, side supports to provide load bearing capacity to the top, a hinged center divider and a solid or frame back side. The sides of the truck bed itself serve as the left (L) and right (R) side walls of the containment system.

The design of the containment system is such that the front and back sides can be folded onto the center divider and secured in the collapsed position for ease of storage when not installed and to provide access to the truck bed itself when the containment system is installed though not in use. As a result, for this design, the stored space requirement of the containment system is reduced from approximately 38.2 ft³ to 8.1 ft³, a reduction of 79% in required storage space. When installed in the truck bed, collapsed and secured, the result is an additional 30.1 ft³ of useable truck bed space. Actual space savings may vary, dependant on design modifications to accommodate make, model, and year of various trucks.

The foregoing has outlined, in general, the physical aspects of the invention and is to serve as an aid to better understanding the more complete detailed description which follows. The present invention is not limited to the method or detail of construction, fabrication, material, or application of use described and illustrated herein. Any other variation of fabrication, use, or application should be considered apparent as an alternative embodiment of the present invention.

### OBJECTS OF THE INVENTION

Accordingly several advantages and objects of the present invention are:

A principal object of the present invention is to provide a method of containment, housing and secure transportation of animals in a truck bed unit that will overcome the deficiencies of the prior art devices.

An object of the present invention is to provide a collapsible, small form factor method of storing the device when installed though not in use, or when de-installed.

### BRIEF DESCRIPTION OF THE DRAWINGS

The following drawings further describe by illustration the advantages and objects of the present invention. Each drawing is referenced by corresponding figure reference characters within the “DETAILED DESCRIPTION OF THE INVENTION” section to follow.

FIG. 1. is a front view of the Collapsible Truck Bed Animal Containment System according to the present invention.

FIG. 2. is a rear view of the Collapsible Truck Bed Animal Containment System according to the present invention.

FIG. 3. is the center frame view of the Collapsible Truck Bed Animal Containment System according to the present invention.

FIG. 4. is a side view of the Collapsible Truck Bed Animal Containment System according to the present invention.

### DETAILED DESCRIPTION OF THE INVENTION

The present invention solves the problems that still exist in prior art because it provides a lightweight, weather-resistant method of securely transporting animals in a truck bed that can be collapsed into a much smaller form factor that simplifies storing the dog box when it is not in use. Referring now descriptively to the drawings, the attached figures illustrate a Collapsible Truck Bed Animal Containment System.

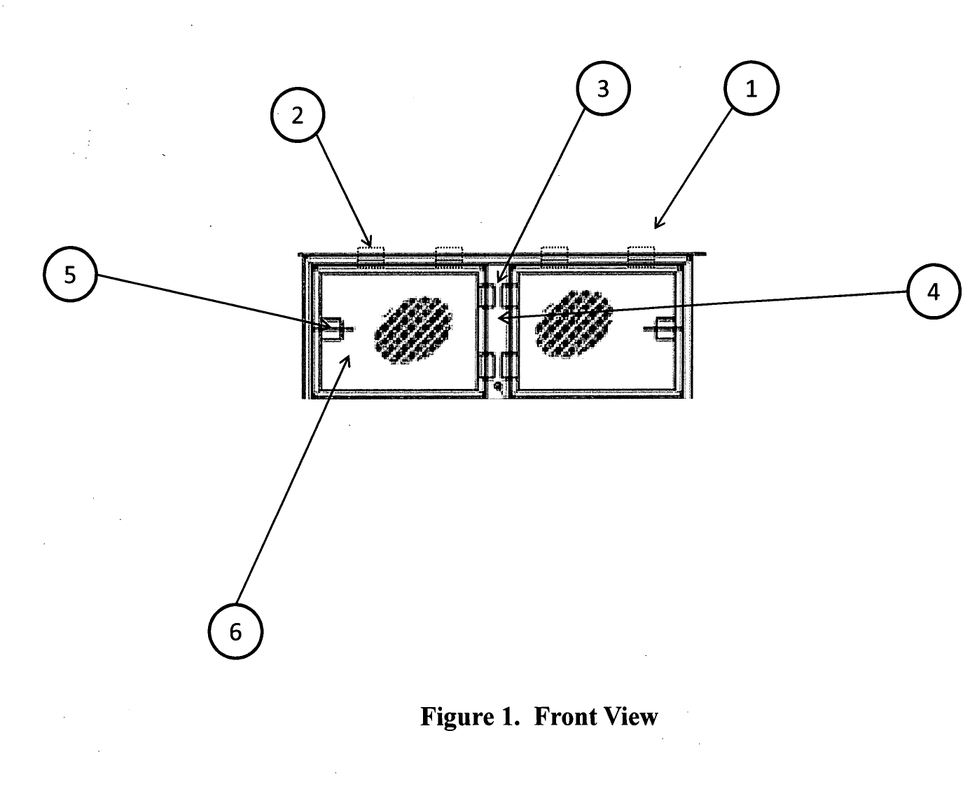

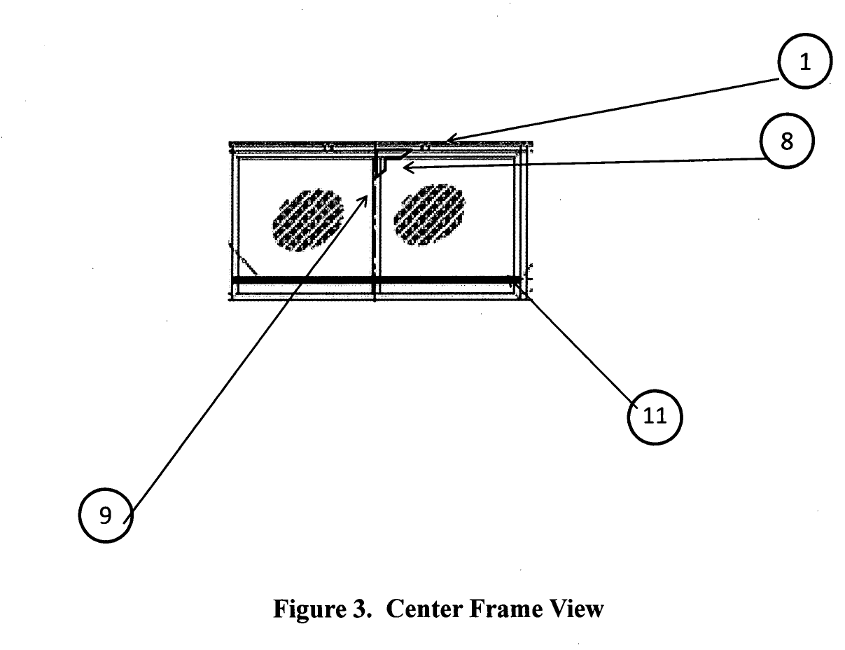

FIG. 1 illustrates the front view of the Collapsible Truck Bed Animal Containment System. It consists of a solid top (1) which will support the weight of an average sized human being and will be secured to the center member depicted in FIG. 3, a front wall (4) with four hinges (2) that will allow the wall to swing approximately 180 degrees, two hinged (3) latching doors (6) with handles (5).

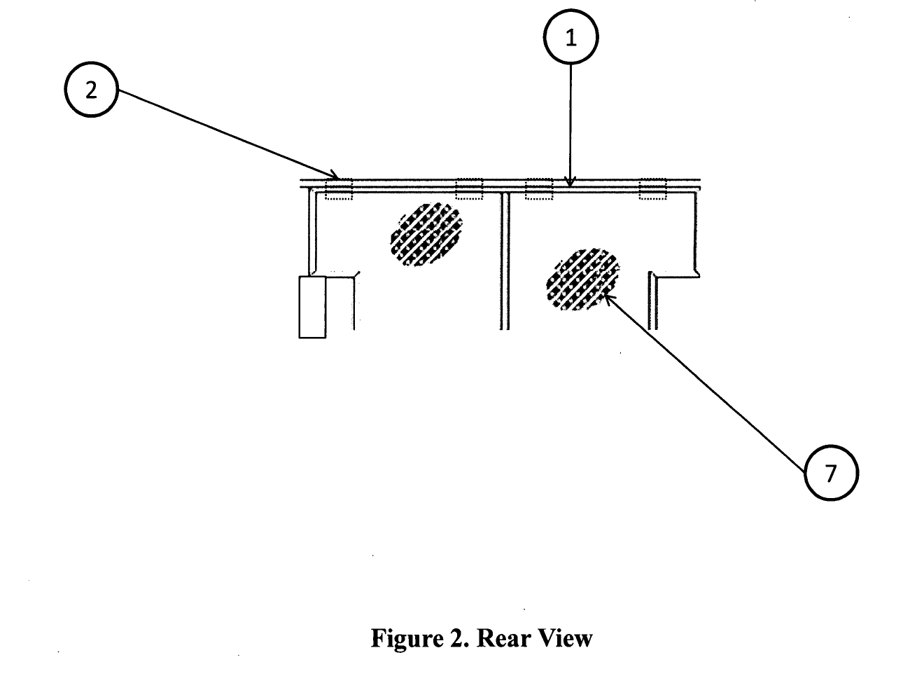

FIG. 2 illustrates the rear view of the Collapsible Truck Bed Animal Containment System. It consists of a solid top (1) which will support the weight of an average sized human being and will be secured to the center member depicted in FIG. 3, a rear wall (7) with four hinges mounted on the interior side of the wall (2) that will allow the wall to swing approximately 180 degrees.

FIG. 3 illustrates a the center frame view of the Collapsible Truck Bed Animal Containment System. It consists of a solid top (1) which will support the weight of an average sized human being and will be secured to the center member (9) with four hinges (8) that will allow the center member to swing approximately 180 degrees. The apparatus uses a locking rod (11) to ensure that the frame remains stable.

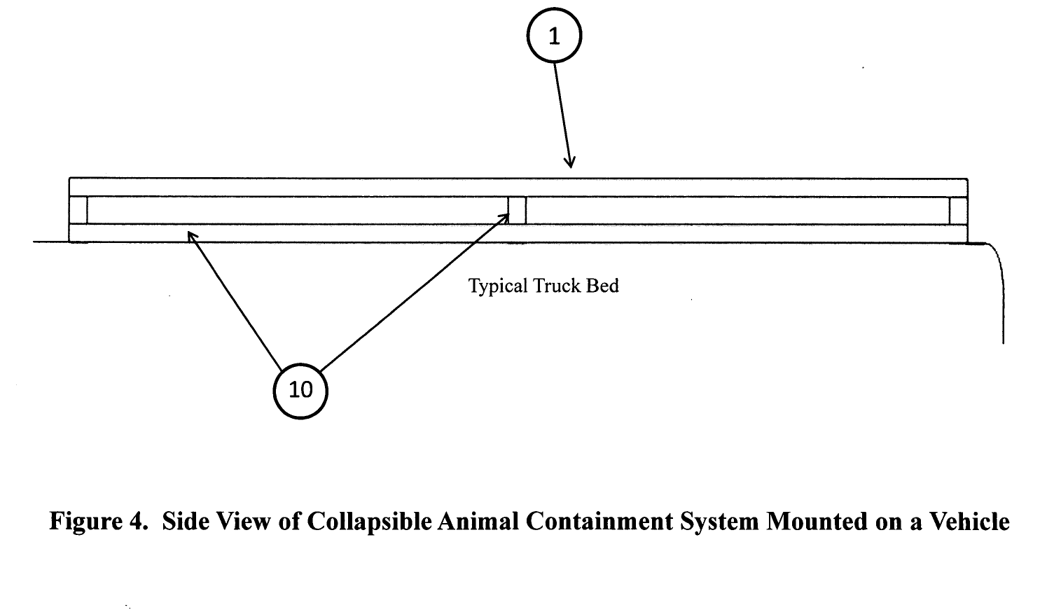

FIG. 4 illustrates a side view of the Collapsible Truck Bed Animal Containment System. It consists of a solid top (1) which will support the weight of an average sized human being and will be secured to the center member depicted in FIG. 3 and a square tubing frame (10) that increase load bearing capacity of the top (1).

It is further intended that any other embodiments of the present invention that result from any changes in application or method of use or operation, method of manufacture, shape, size, or material which are not specified within the detailed written description or illustrations contained herein yet are considered apparent or obvious to one skilled in the art are within the scope of the present invention.

I claim:

1. A lightweight, weather-resistant method of securely transporting animals in a truck bed.

2. A full size enclosure capable of carrying any size dog or small animal that can be collapsed into a much smaller form factor that simplifies storing the dog box when it is not in use

3. An animal containment system which consists of a solid top which will support the weight of an average sized human being and will be secured to the center member with the side of the truck serving as the sides and a center member which allow separation of multiple animals during transportation.
